(19) United States
(12) Patent Application Publication
(10) Pub. No.: US 2021/0387177 A1
(43) Pub. Date: Dec. 16, 2021

(54) DESALTING DEVICES AND PRESSURE-RESISTANT SIZING MEDIA

(71) Applicant: Waters Technologies Corporation, Milford, MA (US)

(72) Inventors: Anna Boardman, Watertown, MA (US); Wenjing Li, Shrewsbury, MA (US); Beatrice Muriithi, Attleboro, MA (US); Mingcheng Xu, Lexington, MA (US); Matthew A. Lauber, North Smithfield, RI (US)

(73) Assignee: Waters Technologies Corporation, Milford, MA (US)

(21) Appl. No.: 17/314,782

(22) Filed: May 7, 2021

Related U.S. Application Data
(60) Provisional application No. 63/038,354, filed on Jun. 12, 2020.

(51) Int. Cl. B01L 3/00; G01N 1/40; B01L 3/02

(52) U.S. Cl. CPC B01L 3/502; G01N 1/4077; B01L 3/021; G01N 1/4044; B01L 2200/026; B01L 2300/123; B01L 2400/0487; B01L 2200/0615; B01L 2300/0883

(57) ABSTRACT

The present disclosure relates to a system for separating a sample including a device and a positive pressure source. The device can include a housing with a proximal end having an interface and a proximal end opening, a distal end opening opposite the proximal end opening, and an interior wall defining an interior of the housing; a bottom frit connected to the interior wall, extending across the interior of the housing, and located proximately to the distal end to minimize sample loss; and a resin disposed within the interior of the housing between the bottom frit and the proximal end. The positive pressure source can connect to the interface of the proximal end to apply positive pressure to the sample. A controller can control the applied positive pressure to the sample via the positive pressure source according to a relationship between the bottom frit, the resin, and the positive pressure.

### CROSS-REFERENCE TO RELATED APPLICATIONS

This application claims benefit and priority to U.S. Provisional Application No. 63/038,354, filed Jun. 12, 2020, entitled “Desalting Devices and Pressure-Resistant Sizing Media.” The content of which is incorporated herein by reference in its entirety.

### FIELD OF THE TECHNOLOGY

The present disclosure relates generally to sample cleanup. More specifically, the present disclosure relates to desalting devices and to cleanup samples.

### BACKGROUND

Scientists routinely purify samples, such as biomolecules, from complex mixtures. The purification workflow includes multiple steps where buffer exchange/desalting processes can be utilized. Desalting through traditional processes, such as gel filtration, could take up to 30 minutes for one sample.

### SUMMARY

The present disclosure is a device, such as a pipette tip-based apparatus, designed to have the flexibility and simplicity to address sample clean-up needs quickly. The device removes salts from aqueous solutions under pressure provided by a handheld pipette, a positive pressure manifold, or other positive pressure source. The device can withstand pressure supplied through standard laboratory equipment due to the pressure-resistant sizing media within the device. The pressure-resistant sizing media, such as a resin, has enough strength and rigidity to tolerate pressure while providing the capability to hinder the flow path of smaller molecules while allowing larger molecules to exit the device rapidly. Consequently, the device will offer fast and pristine sample clean-up and recovery.

Compared to existing technology, the device interfaces with pressure creating equipment and simultaneously offers high recovery, fast and simple operation, and seamless integration to downstream analysis including trypsin digestion and liquid chromatography-based characterization and quantification assays. Protein samples can be successfully processed without the need for centrifugation, quickly surpassing current gravity-flow devices.

Due to the ubiquitous nature of desalting in research and development, a device that can quickly provide unsurpassed large molecule recovery using a simple handheld pipette, or other device, provides great benefit to scientists. Examples of the application in the biopharmaceutical field include fast online/offline desalting before intact/native analysis, sample preparation before enzymatic reaction like digestion or deglycosylation, buffer exchange, and automated workflows on all workflows mentioned above based on smart pipettes (e.g., smart pipettes available from Andrew Alliance USA Inc., Waltham, Mass.) or SPE workstations (e.g., Apricot SPE Automated Processor ((ASAP96) available from Apricot Designs, Inc., Covina, Calif.) or Waters OTTO SPEcialist (available from Waters Technologies Corporation, Milford, Mass.)).

The present disclosure provides a system for separating a sample including a device and a positive pressure source. The device can include a housing with a proximal end having an interface and a proximal end opening, a distal end opening opposite the proximal end opening, and an interior wall defining an interior of the housing; a bottom frit connected to the interior wall, extending across the interior of the housing, and located proximately to the distal end to minimize sample loss; and a resin disposed within the interior of the housing between the bottom frit and the proximal end. The positive pressure source can be connected to the interface of the proximal end to apply positive pressure to the sample. A controller can be configured to control the applied positive pressure to the sample via the positive pressure source according to a relationship between the bottom frit, the resin, and the positive pressure.

In some embodiments, the resin is a pressure-resistant resin to desalt the sample. In some embodiments, the positive pressure source is a handheld pipette or a positive pressure manifold. In some embodiments, the housing includes a coiled or a serpentine flow path within the interior of the housing to increase the path-length of the sample within the interior of the device. In some embodiments, the housing is configured to interface with a handheld pipette to provide bi-directional flow for the device. In some embodiments, the device includes a top frit located between the resin and the proximal end. In some embodiments, the resin comprises a first resin located proximately to the top frit and a second resin located proximately to the bottom frit and a middle frit can separate the first resin and the second resin, wherein the middle frit is located between the bottom frit and the top frit.

In some embodiments, at least two of the frits are identical, and the first resin and the second resin are identical. In some embodiments, the resin comprises spherical or non-spherical porous materials. In some embodiments, the device includes a coating layer on an exterior of the porous material, and the coating layer can include a plurality of hydrophilic diols or polyethylene glycols to reduce undesired interactions between analytes of interest and the resin. In some embodiments, the resin comprises a silica, polymer, cellulose or cross-linked agarose can have particle size ranging from about 20 μm to about 200 μm. In some embodiments, the resin is particle, a membrane, or a monolith. In some embodiments, the sample can be a protein, a nucleic acid, a nucleoprotein complex, a peptide, a polysaccharide, or a viral particle.

The present disclosure provides a method of processing a sample comprising protein, the method includes: adding the sample. The present disclosure also provides a method for purifying a sample. The method includes introducing a sample into a device. The device includes a housing with a proximal end having an interface and a proximal end opening, a distal end opening opposite the proximal end opening, and an interior wall defining an interior of the housing; a bottom frit connected to the interior wall, extending across the interior of the housing, and located proximately to the distal end to minimize sample loss; and a resin disposed within the interior of the housing between the bottom frit and the proximal end. The method also includes applying positive pressure from a positive pressure source connected to the interface of the proximal end to apply positive pressure to the sample.

In some embodiments, purifying the sample comprises desalting the sample. In some embodiments, the method further includes digesting the desalted sample with an immobilized protease or immobilized glycosidase. In some embodiments, applying positive pressure comprises applying positive pressure from a handheld pipette or a positive pressure manifold. In some embodiments, the housing is configured to interface with a handheld pipette to provide bi-directional flow, and the method further includes aspirating and dispensing the sample from the device. In some embodiments, the method further includes controlling via a controller the applied positive pressure to the sample via the positive pressure source according to a relationship between the bottom frit, the resin, and the positive pressure.

### BRIEF DESCRIPTION OF THE DRAWINGS

The technology will be more fully understood from the following detailed description taken in conjunction with the accompanying drawings, in which:

FIG. 1 is a flowchart of an example of digestion current workflow.

FIG. 2A is representation of a desalting device, according to one embodiment of the disclosure.

FIG. 2B is a cross-sectional view of the desalting device of FIG. 2A.

FIG. 3A is an example aspect ratio of the housing of the desalting device, according to one embodiment of the disclosure.

FIG. 3B is an example aspect ratio of the housing of the desalting device, according to one embodiment of the disclosure.

FIG. 4 is a graph of results using 400 μL wet packed tips for recovered volume, recovered protein concentration, protein recovery percentage, and protein per digestion.

FIG. 5 is a bar graph of results for bovine serum albumin recovery percentage.

FIG. 6 is a graph displaying pressure versus volume.

### DETAILED DESCRIPTION

Traditionally, desalting through gel filtration usually takes an extended period of time (e.g., up to 30 minutes for one sample). In addition, currently available devices suffer from 20-50% recovery and create biased results when processing complex samples. Consequently, there exists a need for a high recovery system which ensures the quality of each analyte and the reproducibility of the assay for optimizing biomedical research and regulated analysis. Here, the present disclosure assists scientists to perform routine desalting procedures quickly, easily, and with high recovery by using resin in devices, such as a pipette tip-based apparatus.

Desalting is a ubiquitous process in modern laboratories. Samples often contain contaminants that are not compatible with downstream workflows rendering desalting necessary prior to analysis. However, the desalting process can be tedious and slow, which can be detrimental for some experimental processes (working with reduced peptides, for example).

There are many commercially available desalting devices on the market. One common desalting method uses gravity-flow columns to separate the macromolecule of interest. Here, the limitation is time, as gravity-flow columns rely on gravity and a buffer chaser to push the sample through the resin bed. Another desalting method—spin desalting—uses centrifuge columns that benefit from the force generated by a centrifuge to drive the sample through the resin bed. Consequently, spin desalting is faster than gravity-flow columns; however, a centrifuge is required, which takes up valuable bench space. There are other desalting devices on the market that can desalt samples quickly (similar to the spin columns); however, these desalting devices require large, expensive automatic liquid handling robots.

The present disclosure addresses the need for rapid removal of small molecules from samples, by using a pressure-resistant sizing media housed within a pipette tip-based device which interfaces with handheld pipettes and positive pressure sources. In addition, the present disclosure provides a fast desalting process, which can be completed in seconds, inevitably improving the throughput of various sample preparation procedures and enabling efficient decision-making processes.

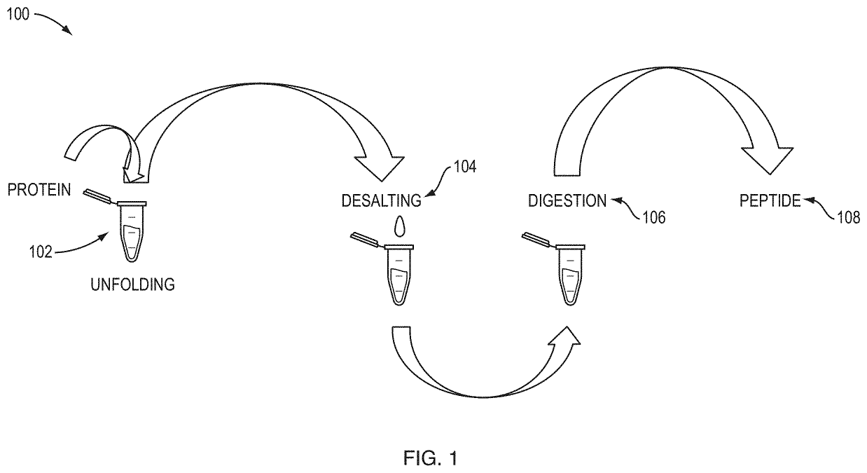

FIG. 1 is a flow chart illustrating an overview of the peptide mapping workflow 100. In some examples, peptide mapping workflow 100 includes four parts. A part one 102 includes a sample with an analyte of interest, such as a protein, that is unfolded. A part two 104 includes desalting the sample, which includes the unfolded analyte of interest. Here, desalting devices and pressure-resistant sizing media can be used to desalt the sample. A part three 106 includes digesting the analyte of interest of the sample. For example, the desalted sample can be digested by an enzyme, which can be immobilized, such as, an immobilized protease or immobilized glycosidase. After the analyte of interest is digested, a part four 108 includes collecting the sample with digested analyte of interest.

Part one 102 and part two 104 can be considered pre-treatment steps. Part one 102 and part two 104 can be dependent on the analyte of interest. In some examples, proteins that can be easily denatured by heat and are introduced during digestion do not require pretreatment. For proteins that need pretreatment, denaturation followed with reduction and alkylation are common steps to fully unfold the protein. After part one 102 where the protein of the sample is unfolded, part two 104 is often required to desalt the sample. Besides protein, the analyte of interest can be a nucleic acid, nucleoprotein complex, peptide, or viral particles.

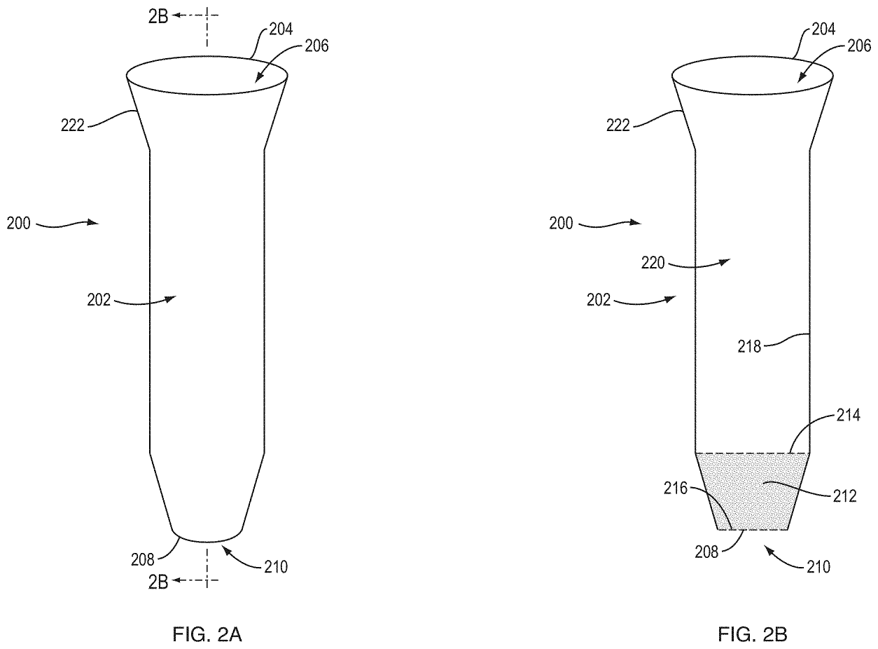

FIG. 2A is a desalting device 200, according to one embodiment of the present disclosure that can be used in part two 104. FIG. 2B is a cutaway of desalting device 200 of FIG. 2A. The present disclosure includes desalting device 200 composed of a housing 202 with a proximal end 204 and a proximal end opening 206. Desalting device 200 can have a pipette tip-based form factor. Opposite proximal end 204 is a distal end 208 with a distal end opening 210. Housing 202 includes an interior wall 218 that defines an interior 220 of housing 202. Desalting device 200 can include a pressure-resistant sizing media (e.g., a resin) 212 between a top frit 214 and a bottom frit 216. Proximal end 204 can include an interface 222 to connect with a pipette or other device.

Housing 202 can be made from a range of materials including polymers, such as, polypropylene, polystyrene, or polyethylene. Housing 202 via interface 222 connects with handheld pipettes and positive pressure sources for liquid handling. Housing 202 can have a variety of form factors including a range of diameters, heights, and/or tapers via interface 222 to connect with a variety of handheld pipettes, such as 1, 10, 20, 50, 100, 200, 300, 1000, 1200, 5000 μL handheld pipettes.

For each volume and brand of pipette, housing 202 can be specifically designed to interface with the liquid manipulator. For example, housing 202 is designed to interface with a Gilson P300 (available from Gilson Incorporated, Middleton, Wis.) and interior 220 has a working volume of 300+μL.

Housing 202 can also be designed to be a universal housing to connect via interface 222 with common handheld pipettes with similar working volumes (Gilson and Eppendorf single- and multi-channel pipettes in the 1000+μL range) as well as positive pressure sources. Housing 202 must be able to accommodate various sizes of pressure-resistant sizing media 212. In some examples, pressure resistant sizing media 212 can be 300-500 μL. In order to accommodate pressure resistant sizing media 212, volume for housing 202 can extend to 1 mL to 1.2 mL, or larger, such as 5 mL.

Most often, the volume of the sample will determine the volume of pressure-resistant sizing media 212, which will in turn determine the volume of housing 202. For example, a 100-200 μL sample requires a volume of 200-800 μL for pressure-resistant sizing media 212. And a 10-50 μL sample requires a volume of 20-200 μL for pressure-resistant sizing media 212.

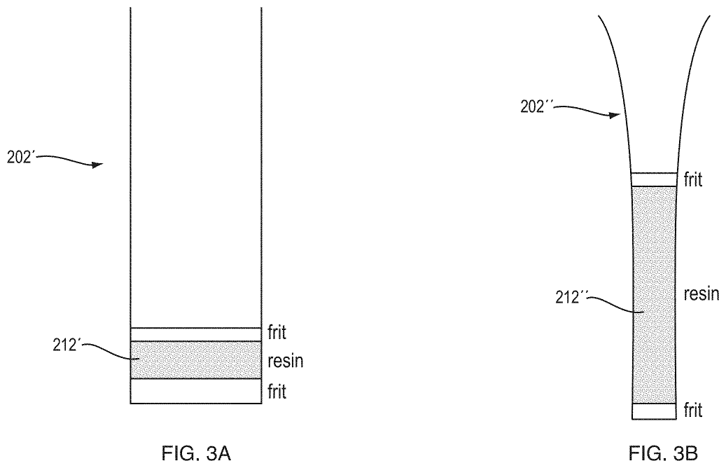

The aspect ratio (length to diameter) of housing 202 can be tailored to fit applicable workflows. For example, for a given volume of pressure-resistant sizing media 212, housing 202′ can accommodate a shorter, wider bed (a small length/diameter ratio as shown in FIG. 3A pressure-resistant sizing media 212′) or, alternatively, a longer, more narrow housing 202″ (with a large length/diameter ratio as shown in FIG. 3B pressure-resistant sizing media 212″) to increase resolution. Besides varying the aspect ratio, the amount of pressure-resistant sizing media 212 can be varied to achieve the desired flow rate and resolution.

Another means of increasing resolution is to increase the path length of the flow path within interior 220 of housing 202. A number of varied flow path shapes and sizes can be used to increase flow path length. For example, a coiled or serpentine flow path within desalting device 200 can be used to increase flow path length.

Since housing 202 can interface with handheld pipettes, bi-directional flow (aspirating and dispensing) is a valued attribute of desalting device 200.

Housing 202 contains pressure-resistant sizing media 212 and frit(s) (e.g., top frit 214 and/or bottom frit 216). Similar to traditional desalting devices, pressure-resistant sizing media 212 can be contained between two frits to ensure pressure-resistant sizing media 212 remains within a tip of desalting device 200 (FIG. 2), even during accidental aspiration.

Any combination of fits and medias can be used together. The examples described herein are meant for illustrative purposes only and not to be construed as limiting examples.

Above bottom frit 216, pressure-resistant sizing media 212 is positioned at distal end opening 210, the tip's outlet. A range of volumes and modes can be utilized for pressure-resistant sizing media 212. Modes include desalting, buffer exchange, solid phase extraction (e.g., Oasis mediums (e.g., Oasis sample extraction products available from Waters Technologies Corporation, Milford, Mass.)), sample preparation products (e.g., Ostro Pass-through Sample Preparation Products available from Waters Technologies Corporation, Milford, Mass.)), affinity capture, sample clean-up employing anti-human IgG, streptavidin/biotinylated targets, nanobodies, aptamers, particles with custom ligands attached to the surface, amongst others.

In a mixed mode example, multiple pressure-resistant sizing medias 212 (e.g., resin beds) could be stacked back to back, with or without frits between them within a single device, desalting device 200.

Instead of top frit 214 and bottom frit 216, a single frit (e.g., bottom frit 216 only, and not top frit 214) can be positioned at the outlet end of the tip, i.e., the distal opening 210 at distal end 208; in this example with only bottom frit 216, desalting device 200 can be used exclusively for top-loading processes with an advantage of faster flow characteristics due to minimal resistance from having only one frit (bottom frit 216). Here, bottom frit 216 is positioned closely to distal end 208 of desalting device 200 to minimize sample loss. In some examples, bottom frit 216 is coplanar with distal end opening 210. Stated another way, bottom frit 216 can be flush against distal end 208 so no dead volume exists when eluting a sample. By decreasing the amount of sample left remaining on desalting device 200, sample recovery can be increased.

Distal end 208 can be flexible in the dimension of the diameter as well as length. Distal end opening 210 can also be tailored to produce a desired droplet volume.

The frit properties (e.g., material/shape/thickness/pore size/pore shape/pore volume) can be selected based on pressure-resistant sizing media 212. Frits can be screens, meshes, membranes of different sizes (which still fit within the inner diameter of housing 202). Frits can be various shapes including spherical, conical, or frusto-conical. The hydrophobicity (hydrophilic and hydrophobic) of the frits can vary depending on the application of desalting device 200. The material of the frits includes polyethylene, polypropylene, or Teflon™ (available from The Chemours Company, Wilmington, Del.). The thickness of frits can range from about 0.1 mm to about 5 mm. The fits can be connected to interior wall 218 by a friction fit among other means.

One example of varying frit properties based on the application of the desalting device 200 includes increasing retention of pressure-resistant sizing media 212 and maximizing solvent flow rate. Here, for example, when 60 μm spherical particles are chosen for pressure-resistant sizing media 212, top frit 214 and bottom frit 216 can have an average pore size of 50 μm and a thickness of 1.5 mm, to provide a device with a pore size that allows for a high flow rate while still retaining the media.

Frits can be identical or different from the other. As shown in FIG. 2B where top frit 214 and a bottom frit 216 surround pressure-resistant sizing media 212, top frit 214 and bottom frit 216 can be identical. Or, top frit 214 can be different from bottom frit 216. For example, top frit 214 can have larger pore size and a softer material than bottom frit 216.

Multiple frits (e.g., top frit 214 and bottom frit 214) can be used in desalting device 200. Frits can be placed directly next to one another with no media between the fits. For example, there may be three top frits 214 placed directly next to one another and one bottom frit 216 separated by pressure-resistant sizing media 212. Multiple frits could be used to separate different pressure resistant sizing medias 212 in a mixed mode situation.

There may also be multiple pressure-resistant sizing media 212 used together in desalting device 200 that are either identical or different from one another. For example, multiple pressure-resistant sizing media 212 may be stacked directly next to one another and used with one frit, bottom frit 216. Or, multiple (two or more) identical pressure-resistant sizing media 212 could be stacked between multiple (two or more) frits.

In some examples, top frit 214 and bottom frit 216 sandwich a first and second resin of pressure-resistant sizing media 212. A middle frit can separate the first and second resin, which can be identical or different from one another. In some applications, there is no top frit 216.

In certain applications, top frit 214 and bottom frit 216 can act as flow restrictors. The properties of top frit 214 and bottom frit 216 (e.g., material/shape/thickness/pore size/pore shape/pore volume) can be adjusted to achieve the desired solvent flow rate. By slowing the solvent flow, more time allows for the sample to interact with particles from pressure-resistant sizing media 212.

Examples of pressure-resistant sizing media 212 include but are not limited to spherical or non-spherical porous materials made from dextran, agarose, cross-linked agarose, sepharose, cellulose, silica, hybrid silica, polymers, synthetic polymers, or black carbon with desired pore size. The porous materials of pressure-resistant sizing media 212 can be either neutral or can bear permanent surface charge or other functionalities. For example, the interior surface of the pores of pressure-resistant sizing media 212 can be modified with a surface charge or other functionalities to increase the desalting efficiency while the exterior of the porous materials of pressure-resistant sizing media 212 is coated with a hydrophilic layer to eliminate undesired interactions with analytes of interest such as target molecules.

Pressure-resistant sizing media 212 can be a particle, a membrane, or a monolith. Pressure-resistant sizing media 212 can have a narrow particle size distribution. In some examples, pressure-resistant sizing media 212 can a resin of porous material with pore size of less than 50 Å or ranging from about 3 nm to 10 nm.

Pressure-resistant of pressure-resistant sizing media 212 is defined as follows: capable of handling pressures ranging from 0.1 psi to a maximum of 50 psi and pressurized flow rate extending from 0.1 μL/s to 20 μL/s. Depending on the application of desalting device 200, pressure-resistant sizing media 212 will be required to withstand varying pressures. The selection of pressure-resistant sizing media 212 for desalting device 200 will be based on, at least in part, the pressure resistant requirements.

Coatings can provide additional benefits for desalting device 200 during sample processing. Advantages include minimizing non-specific bonding, additional separation techniques, providing hydrophobicity/hydrophilicity, inhibiting protein adsorption and wettability manipulation. Identical or different coatings can be applied to each component of desalting device 200 including but not limited to housing 202, pressure-resistant sizing media 212, top frit 214, and bottom frit 216. The coatings can be polymer-based (for wettability or separation properties) or metal (for thermal and electrical properties) at a range of thicknesses (monolayer to 1 μm). There can be a single type of coating or a combination of coatings within each desalting device 200 or within each component of desalting device 200.

The coating layer can be on an exterior of the porous material (i.e., a pore surface) of pressure-resistant sizing media 212. The coating layer can include one or more functionalities. For example, a functionality can include a plurality of hydrophilic diols or polyethylene glycols to reduce undesired interactions between analytes of interest and pressure-resistant sizing media 212. Stated another way, the coating layer can reduce non-specific binding of the target biomolecules. The coating layer can be applied by either chemical bonding or physical adsorption. The functionality can also be an ion exchange group or a ligand. The ligand can be any chemical or biological moieties that can interact with the target analytes.

The interior surfaces of desalting device 200 can be coated with a coating, such as a hydrophilic coating, to eliminated secondary interactions with the target analyte. For example, interior wall 218 can be coated with a hydrophilic coating to eliminate secondary interactions with a protein.

If pressure-resistant sizing media 212 must be shipped wet in a solvent, desalting device 200 can be sealed to preserve pressure-resistant sizing media 212 and its storage solution. A resin bed of pressure-resistant sizing media 212 can vary for desalting device 200. In some examples, the resin bed can range from 350 μL to 425 μL. Variable amounts of storage solution can be used based (e.g., 20% ethanol as shipped wet). For example, covering both outlets, proximal end opening 206 and distal end opening 210, of desalting device 200 may be required. Separable lids, tip covers, flap caps, cap mitts, tip caps, tip plugs, and other seal-creating modalities in singles, strips, mats, or perforated selections are options to uphold the integrity of pressure-resistant sizing media 212 during storage.

In some examples, desalting device 200 can be in an 8×12 format (96 desalting devices 200). Other formats are also included such as 3×8 formats (24 desalting devices 200). At proximal end 204, there can be a 96-cap mat with perforated columns. A removable tip tray can also be disposed proximately to proximal end 204 to hold tips of desalting device 200. In some examples, desalting device 200 can be a 1.2 mL extended pipette tip (available from Sartorius AG, Göttingen, Germany).

In some examples, desalting device 200 comes in an 8×12 format with 96-cap mat with perforated columns, removable tip tray to hold desalting device 200, variable amounts of storage solution for each desalting device 200, resin beds of pressure-resistant sizing media 212 varying (e.g., 350 μL to 425 μL), single tip caps in silicone, and one spherical frit, bottom frit 216, (20 μm-30 μm porosity, 0.075″ diameter, ultra-high-molecular-weight polyethylene (UHMWPE)).

In some examples, resin bed of pressure-resistant sizing media 212 can be a dry bed—vacuum or oven dried. With a dry bed, there is no storage solution. No bottom tip caps are required.

In some examples, the positive pressure source connected via interface 222 can be automated. The means for automating can include a pump connected to interface 222, an automated means for actuating the pump, and a controller.

The automated means for actuating the pump can be controlled by software. This software controls the pump, and can be programmed to introduce desired liquids into desalting device 200, as well as to evacuating the liquid by the positive introduction of gas. In some examples, the automated means can include a controller with software.

In some examples, the controller can be a processing device that may be one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like.

In some examples, the software can control a robot, which then controls the pump/pipette. For example, OneLab can be used to control Andrew+ (a liquid handling robot that uses single and multichannel electronic pipettes), which controls the Pipette+ (connected electronic pipettes that can execute laboratory protocols designed in OneLab), which interfaces with the tip (products available from Andrew Alliance, a part of Waters Corporation, Milford, Mass.).

OneLab can be used to design tip-based protocols for two automated platforms (Andrew+ and Pipette+). The software can manipulate the filled tips as columns, where positive pressure is applied to the top outlet via the pipette, and as tips, where both aspiration and dispensing can occur, mixing the resin. For this application, only top-loading the resin can be done and loading the resin bed (the pipette never aspirates when the tip is on the pipette).

The pump can take any of a variety of forms, so long as it is capable of generating a positive pressure to discharge fluid out of desalting device 200. In some examples, the pump is also able to generate a negative pressure to aspirate a fluid into desalting device 200 through distal end opening 210.

The pump should be capable of pumping liquid or gas, and should be sufficiently strong so as to be able to push a desired sample solution, wash solution and/or desorption solvent through pressure-resistant sizing media 212.

In some examples, the pump is capable of controlling the volume of fluid aspirated and/or discharged from desalting device 200. This allows for the metered intake and outtake of solvents, which facilitates more precise elution volumes to maximize sample recovery and concentration. In some examples, a controller can be configured to control the applied positive pressure to the sample via the positive pressure source (e.g., pump) according to a relationship between a bottom frit of a device, a resin of the device, and the positive pressure.

Non-limiting examples of suitable pumps include a pipette, syringe, peristaltic pump, pressurized container, centrifugal pump, electrokinetic pump, or an induction based fluidics pump.

Desalting device 200 can be packaged together in a strip of eight desalting devices 200 or multiples thereof (e.g., 8, 16, 24, or 32). The strip of desalting devices 200 could have a weakened union to separate into individual desalting devices 200.

Desalting device 200 can be used in variety of applications besides desalting samples including sample clean-up/separation, filtration, concentration, purification, off-line and on-line analyses. With metal sections/electrodes, desalting device 200 can be used in applications such as electrochemical reduction, electroosmotic flow (EOF), sensing, electrical, magnetic, thermal, impedance. With optically-clear sections, desalting device 200 can be used in applications such as detection (including single cell) and as a reader. Desalting device 200 can be used for glycan sample preparation (as can be done if used in front of the GlycoWorks® N-Glycan kit (available from Waters Technologies Corporation, Milford, Mass.)) and oligonucleotide desalting (as it can be important to the analysis of molecules like antisense oligonucleotides being developed by Alnylam Pharmaceuticals, Inc. (Cambridge, Mass.) and lonis Pharmaceuticals, Inc. (Carlsbad, Calif.)). Desalting device 200 can also be used for desalting and/or crude purification (based on size cutting) of nucleic acid plasmids and viral vectors (like adeno-associated viruses).

One example workflow is removing bottom and top caps from desalting device 200, which can be in an 8×12 format. After removing caps, buffer can be added and eluted from desalting devices 200. Sample can then be added to desalting device 200 and eluted. Next, an enzyme (e.g., Tris) can be added to desalting device 200 and then the sample can be collected.

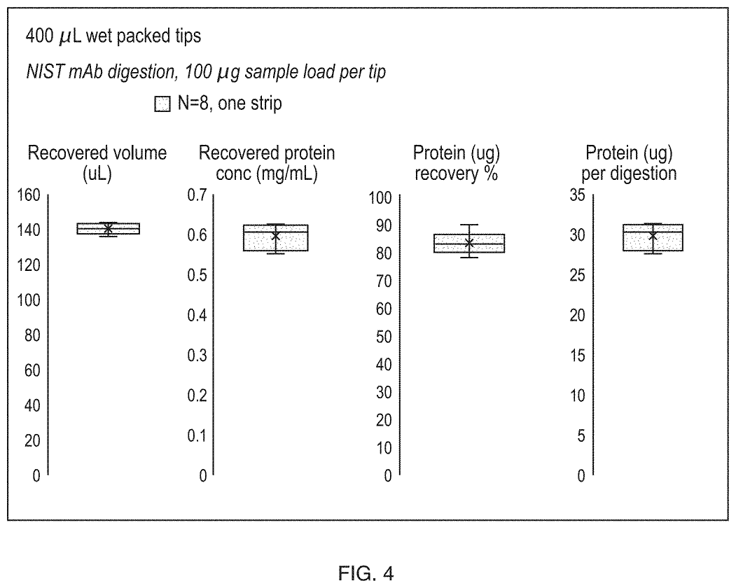

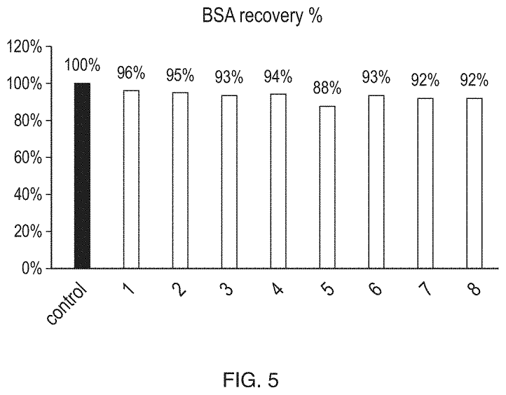

FIG. 4 is a graph of results using 400 μL wet packed tips (desalting device 200) for recovered volume, recovered protein concentration, protein recovery percentage, and protein per digestion. One strip of desalting devices 200 were used (1×8, N=8) with 100 μg sample load per desalting device for NIST mAb digestion. FIG. 4 displays the average results for eight desalting devices 200. The recovered volume was approximately 140 μL with a relative standard deviation (RSD) of 2%. The recovered protein concentration (mg/mL) was approximately 0.6 with a RSD of 5%. The protein (μg) recovery percentage was between 80 and 90 (approximately 82) with a RSD of 4.4%. The protein (μg) per digestion was approximately 30 with a RSD 4.9%. No salt was detected through conductivity, >99% removal. FIG. 5 is a bar graph of results for bovine serum albumin recovery percentage. For the control, there was 100% BSA recovery. The recovery varied between 88% and 96%.

An example of the described device includes a pipette tip containing a frit at the tip's distal end. The desalting resin particles are on the proximal side of the frit. The frit permits liquids to pass, but not resin particles. A spherical frit (e.g., ultra-high-molecular-weight polyethylene (UHMWPE), HDPE (high density PE), PP (polypropylene)), diameter 0.05″-0.125″, porosity 10-40 μm) holds 350-425 μL of desalting resin (dry particles ranging 20-75 μm in diameter) within the 1.2 mL extended tip. The tip interfaces precisely with a 1.2 mL 8-channel digital pipette. Due to the lack of a frit above the resin bed, applying positive pressure via pipette and top-loading liquids are standard means of desalting in this device.

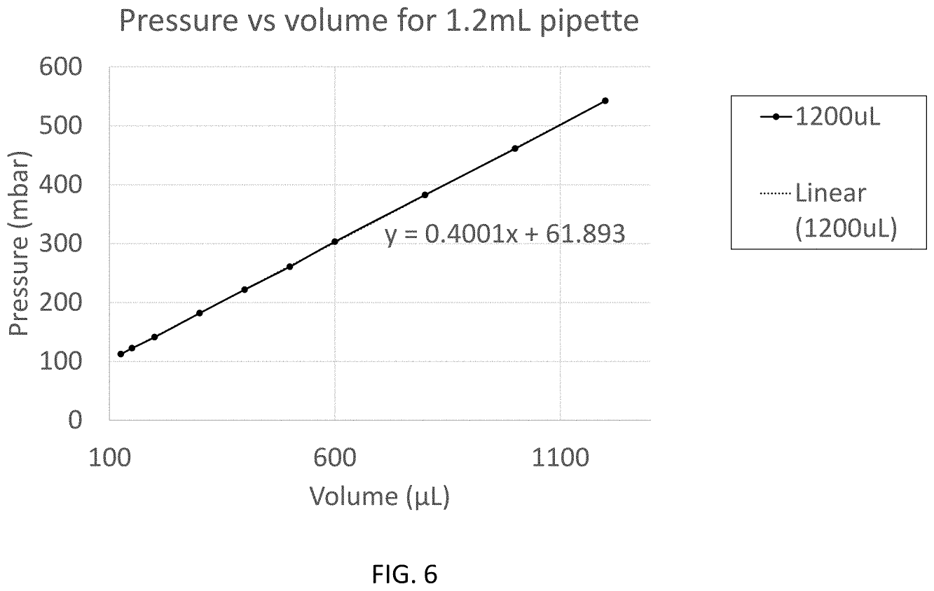

During the procedure, fluid is manipulated by the digital pipette, which can be controlled manually, robotically, and/or with software. For example, for the equilibration step, when 500 μL of enzyme buffer (e.g., Tris) (which was added to the proximal side of the bed) needs to be eluted, the digital pipette is set to 600 μL to account for the backpressure from the frit and resin bed. From Table 1 and FIG. 6 (displaying pressure versus volume), a volume of 600 μL correlates to a pressure of ˜300 mbar compared to a pressure of ˜260 mbar for a volume of 500 μL.

TABLE 1
Pressure versus volume for 1.2 mL pipette

| Volume (μL) | Pressure (mbar) |
|---|---|
| 125 | 112 |
| 150 | 122 |
| 200 | 141 |
| 300 | 181 |
| 400 | 221 |
| 500 | 260 |
| 600 | 303 |
| 800 | 382 |
| 1000 | 461 |
| 1200 | 542 |

Another example could be during the sample elution step when 150 μL of enzyme (e.g., Tris) is eluted. In this case, the pipette is set to 200 μL (˜140 mbar) to accommodate for the extra backpressure from the filled tip (instead of ˜120 mbar for 150 μL elution for a normal, empty pipette tip).

While this disclosure has been particularly shown and described with reference to example embodiments thereof, it will be understood by those skilled in the art that various changes in form and details may be made therein without departing from the scope of the technology encompassed by the appended claims. For example, other chromatography systems or detection systems can be used.

1. A system for separating a sample comprising:
a device comprising:
a housing with a proximal end having an interface and a proximal end opening, a distal end opening opposite the proximal end opening, and an interior wall defining an interior of the housing;
a bottom frit connected to the interior wall, extending across the interior of the housing, and located proximately to the distal end to minimize sample loss; and
a resin disposed within the interior of the housing between the bottom frit and the proximal end;
a positive pressure source connected to the interface of the proximal end to apply positive pressure to the sample; and
a controller configured to control the applied positive pressure to the sample via the positive pressure source according to a relationship between the bottom frit, the resin, and the positive pressure.

2. The system of claim 1, wherein the resin is a pressure-resistant resin to desalt the sample.

3. The system of claim 1, wherein the positive pressure source is a handheld pipette or a positive pressure manifold.

4. The system of claim 1, wherein the housing comprises a coiled or a serpentine flow path within the interior of the housing to increase the path-length of the sample within the interior of the device.

5. The system of claim 1, wherein the sample comprises a protein, a nucleic acid, a nucleoprotein complex, a peptide, a polysaccharide, or a viral particle.

6. The system of claim 1, wherein the housing is configured to interface with a handheld pipette to provide bi-directional flow for the device.

7. The system of claim 1, further comprising a top frit located between the resin and the proximal end.

8. The system of claim 7, wherein the resin comprises a first resin located proximately to the top frit and a second resin located proximately to the bottom frit.

9. The system of claim 8, further comprising a middle frit separating the first resin and the second resin, wherein the middle frit is located between the bottom frit and the top frit.

10. The system of claim 7, wherein at least two of the frits are identical.

11. The system of claim 7, wherein the first resin and the second resin are identical.

12. The system of claim 1, wherein the resin comprises spherical or non-spherical porous materials.

13. The system of claim 12, further comprising a coating layer on an exterior of the porous material.

14. The system of claim 13, wherein the coating layer comprises a plurality of hydrophilic diols or polyethylene glycols to reduce undesired interactions between analytes of interest and the resin.

15. The system of claim 1, wherein the resin comprises a silica, polymer, cellulose or cross-linked agarose.

16. The system of claim 1, wherein the resin comprises materials with particle size ranging from about 20 μm to about 200 μm.

17. The system of claim 1, wherein resin is particle, a membrane, or a monolith.

18. A method for purifying a sample, the method comprising:
introducing a sample into a device, the device comprising:
a housing with a proximal end having an interface and a proximal end opening, a distal end opening opposite the proximal end opening, and an interior wall defining an interior of the housing;
a bottom frit connected to the interior wall, extending across the interior of the housing, and located proximately to the distal end to minimize sample loss; and
a resin disposed within the interior of the housing between the bottom frit and the proximal end; and
applying positive pressure from a positive pressure source connected to the interface of the proximal end to apply positive pressure to the sample.

19. The method of claim 18, wherein purifying the sample comprises desalting the sample.

20. The method of claim 19, further comprising digesting the desalted sample with an immobilized protease or immobilized glycosidase.

21. The method of claim 18, wherein applying positive pressure comprises applying positive pressure from a handheld pipette or a positive pressure manifold.

22. The method of claim 18, wherein the housing is configured to interface with a handheld pipette to provide bi-directional flow, the method further comprising aspirating and dispensing the sample from the device.

23. The method of claim 18, further comprising controlling via a controller the applied positive pressure to the sample via the positive pressure source according to a relationship between the bottom frit, the resin, and the positive pressure.
